(19) United States
(12) Patent Application Publication
(10) Pub. No.: US 2005/0143213 A1
(43) Pub. Date: Jun. 30, 2005

(54) Differential transaxle assembly

(75) Inventor: John W. Cross, Collegeville, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: ASI Technologies, Inc.

(21) Appl. No.: 11/025,553

(22) Filed: Dec. 29, 2004

Related U.S. Application Data
(60) Provisional application No. 60/533,087, filed on Dec. 29, 2003.

(51) Int. Cl. F16H 48/06

(52) U.S. Cl. 475/252

(57) ABSTRACT

A differential transaxle assembly can be used with any one of a plurality of different chassis, each different chassis having a different distance between mounting locations. The differential transaxle assembly includes first and second supports for connecting the differential transaxle assembly to the mounting locations of the chassis, a gear case, and a tube separate from a gear case. A first end of the tube is secured to one of the first and second supports. A second end of the tube is secured to the gear case. The tube surrounds at least one of a first and a second output shaft. The tube length is selected to enable the first and second supports to be appropriately spaced to correspond to the mounting locations of the particular chassis with which the differential transaxle assembly is being used.

### CROSS-REFERENCE TO RELATED APPLICATIONS

This application claims the benefit of U.S. Provisional Patent Application No. 60/533,087, entitled “Differential Transaxle Assembly”, filed Dec. 29, 2003, which is incorporated herein by reference.

### BACKGROUND OF THE INVENTION

The present invention relates generally to differential transaxle assemblies and, more particularly, to a differential transaxle assembly having a tube separate therefrom for attachment to a long shaft end of the differential transaxle assembly.

In conventional differential transaxle assembly designs, the long shaft end of the transaxle is either firmly supported in bearings at a mounting sleeve supported by a cast structure integral with a gear case of the transaxle, or the long shaft is left exposed to the elements with a separate casting at the end of the long shaft supporting the shaft bearing. A problem with the first alternative is that changes in mounting lengths are somewhat expensive to effect, and machining of the housing can be complicated. A problem with the second alternative is that leaving the shaft exposed to the elements not only increases the possibility of corrosion of the shaft but also increases the possibility of physical injury. An additional problem with the second alternative is that, by having no structural connection between the gear case and the bearing support, no reaction torque can be transferred to and carried by the bearing support.

It would therefore be desirable to have a differential transaxle assembly that overcomes these problems. Specifically, it would be desirable to have a differential transaxle assembly that can be manufactured for a cost that is reduced from that of the conventional designs. Additionally, it would be desirable to have a differential transaxle assembly with mounting distances that can be easily changed to accommodate a variety of chassis. Lastly, it would be desirable to provide for the tight enclosure of both rotating axle shafts to reduce the possibilities of corrosion and physical injury.

### BRIEF SUMMARY OF THE INVENTION

Briefly stated, the present invention is a differential transaxle assembly for use with any one of a plurality of different chassis. Each chassis has a pair of mounting locations spaced apart a predetermined distance. Each of the different chassis has a different distance between the mounting locations. The differential transaxle assembly comprises a gear case having a predetermined configuration with a pair of opposed apertures therein. Each of the apertures is aligned along a longitudinal axis of the gear case. The gear case has a gear case length measured along the longitudinal axis between the apertures. The gear case length is less than the distances between the mounting location of the different chassis. A first output shaft is rotatably positioned in one of the apertures and is at least substantially aligned with the longitudinal axis of the gear case. The first output shaft has a first outboard end disposed outside of the gear case. A second output shaft is rotatably positioned in the other of the apertures and is at least substantially aligned with the longitudinal axis of the gear case. The second output shaft has a second outboard end disposed outside of the gear case. First and second supports connect the differential transaxle assembly to the mounting locations of the chassis. The first support is located proximate the first outboard end of the first output shaft. The second support is located proximate the second outboard end of the second output shaft. A tube separate from the gear case has a first end and an oppositely disposed second end and defines a tube length measured between the first and second ends. The first end of the tube is secured to one of the first and second supports. The second end of the tube is secured to the gear case. The tube surrounds at least one of the first and second output shafts. The tube length is such to enable the first and second supports to be appropriately spaced to correspond to the mounting locations of the particular chassis with which the differential transaxle assembly is being used.

In another aspect, the present invention is a differential transaxle assembly for use with any one of a plurality of different chassis. Each chassis has a pair of mounting locations spaced apart a predetermined distance. Each of the different chassis has a different distance between the mounting locations. The differential transaxle assembly comprises a gear case having a predetermined configuration with a pair of opposed apertures therein. Each of the apertures is aligned along a longitudinal axis of the gear case. The gear case has a gear case length measured along the longitudinal axis between the apertures. The gear case length is less than the distances between the mounting locations of the different chassis. A first output shaft is rotatably positioned in one of the apertures and is at least substantially aligned with the longitudinal axis of the gear case. The first output shaft has a first outboard end disposed outside of the gear case. A second output shaft is rotatably positioned in the other of the apertures and is at least substantially aligned with the longitudinal axis of the gear case. The second output shaft has a second outboard end disposed outside of the gear case. First and second supports connect the differential transaxle assembly to the mounting locations of the chassis. The first support is located proximate the first outboard end of the first output shaft, and the second support is located proximate the second outboard end of the second output shaft. A tube separate from the gear case has a first end and an oppositely disposed second end and defines a tube length measured between the first and second ends. The first end of the tube is integrally molded with one of the first and second supports, and the second end of the tube is secured to the gear case. The tube surrounds at least one of the first and second output shafts. The tube length is such to enable the first and second supports to be appropriately spaced to correspond to the mounting locations of the particular chassis with which the differential transaxle assembly is being used.

In another aspect, the present invention is a method for assembling a differential transaxle assembly for use with a chassis having a pair of mounting locations spaced apart a predetermined distance. The method comprises the steps of forming a gear case having a cavity and a pair of opposed apertures in communication with the cavity, such that each of the apertures are aligned along a longitudinal axis of the gear case. The gear case has a predetermined length measured between the apertures. The gear case length is less than the distance between the mounting locations of the chassis. A first output shaft is positioned in one of the apertures, such that the first output shaft is at least substantially aligned with the longitudinal axis of the gear case. The first output shaft has a first inboard end within the cavity and a first outboard end disposed outside of the gear case. A second output shaft is positioned in the other of the apertures, such that the second output shaft is at least substantially aligned with the longitudinal axis of the gear case. The second output shaft has a second inboard end within the cavity and a second outboard end disposed outside of the gear case. A gear assembly is positioned within the cavity in operative engagement with the first and second inboard ends of the first and second output shafts for transferring torque to the first and second output shafts. A tube is formed having a first end and an oppositely disposed second end defining a tube length measured therebetween. The second end of the tube is secured to one of the apertures of the gear case so that the tube is at least substantially aligned with the longitudinal axis of the gear case, with one of the first and second output shafts disposed within the tube. A first support is located at the first end of the tube. A second support is located proximate the other of the apertures of the gear case. The tube length is determined according to the distance between the mounting locations of the chassis so that the first and second supports correspond and align with the mounting locations of the chassis.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a bottom rear partially exploded perspective view of a differential transaxle assembly in accordance with a first preferred embodiment of the present invention shown in relation to a chassis with which the differential transaxle assembly can be used;

FIG. 2 is a rear elevational view of the differential transaxle assembly of FIG. 1;

FIG. 3 is a right-side elevational view of the differential transaxle assembly of FIG. 1;

FIG. 4 is an enlarged cross-sectional view of the differential transaxle assembly of FIG. 1, taken along the line 4-4 of FIG. 3;

FIG. 5 is a rear elevational view of a differential transaxle assembly in accordance with a second preferred embodiment of the present invention;

FIG. 6 is a right-side elevational view of the differential transaxle assembly of FIG. 5;

FIG. 7 is an enlarged cross-sectional view of the differential transaxle assembly of FIG. 5, taken along the line 7-7 of FIG. 6; and

FIG. 8 is an exploded perspective view of the differential transaxle assembly of FIG. 5.

### DETAILED DESCRIPTION OF THE INVENTION

Certain terminology is used in the following description for convenience only and is not limiting. The words “right,”. “left,” “upper,” and “lower” designate directions in the drawings to which reference is made. The terminology includes the words above specifically mentioned, derivatives thereof, and words of similar import.

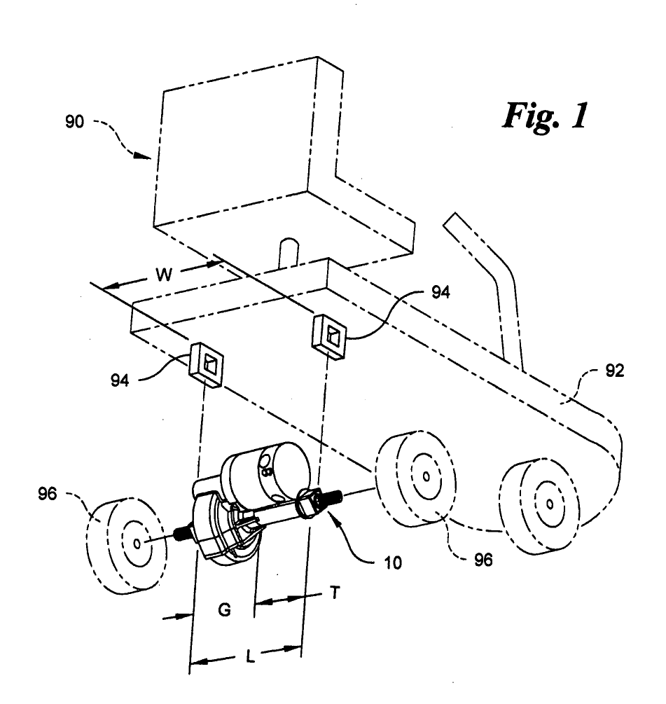

Referring to the drawings in details, wherein like numerals indicate like elements throughout, there is shown in FIGS. 1-4 a differential transaxle assembly, indicated generally at 10, in accordance with a first preferred embodiment of the present invention.

Referring to FIG. 1, the differential transaxle assembly 10 is intended for use with any one of a plurality of different chassis, the plurality of different chassis being associated with various powered vehicles and machines. Although FIG. 1 and the description below describe the use of the differential transaxle assembly 10 with a chassis 92 of an electric scooter 90 for use by elderly and/or otherwise at least slightly incapacitated people, it is within the spirit and scope of the present invention that the differential transaxle assembly 10 be used with chassis of other types of machines, automobiles and vehicles, such as, but not limited to, golf carts, floor cleaning machines and shopping cart pulling machines. Also, although described in the context of electrically-powered devices, it is within the spirit and scope of the present invention that the differential transaxle assembly 10 be used with vehicles and machines powered by alternate means, such as gasoline or natural gas motors, for instance.

The chassis 92 has a pair of mounting locations 94 spaced apart a predetermined distance W. The distance W between the mounting locations 94 varies according to the vehicle or machine with which it is being used. Even with respect to the scooter 90, depending on the size and type of the scooter 90, the distance W between the mounting locations 94 of the chassis 92 will vary. As will be described below, a mounting length L of the differential transaxle assembly 10 can be relatively easily altered in order to attach the differential transaxle assembly 10 to the mounting locations 94 of the chassis 92, regardless of the distance W therebetween. That is, the differential transaxle assembly 10 can be readily sized to fit different size vehicles. Once attached to the chassis 92, the differential transaxle assembly 10 functions to power wheels 96 rotatably attached thereto in order to drive the scooter 90 along a surface.

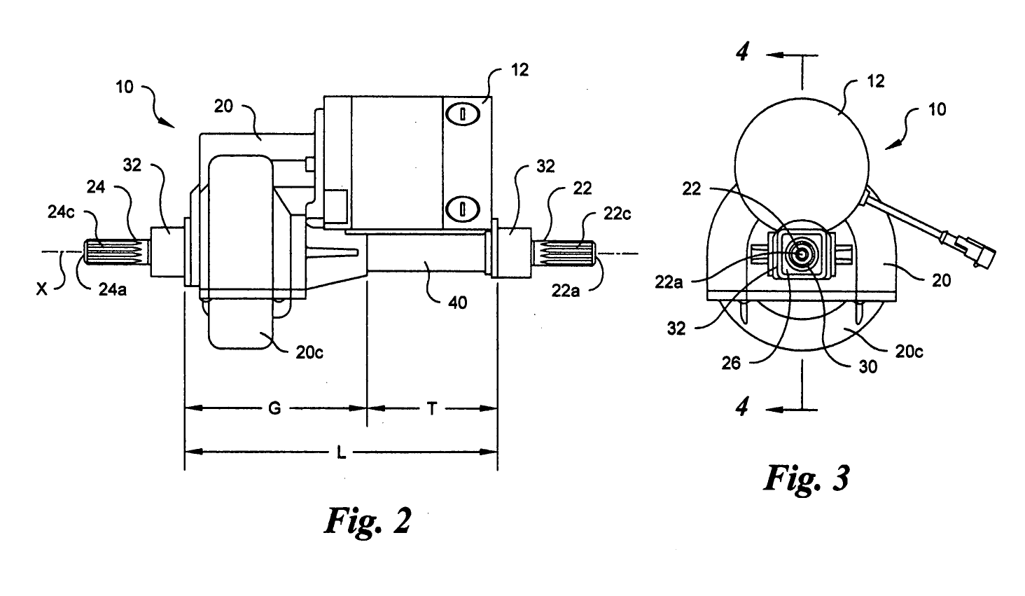

Referring to FIGS. 2-4, the differential transaxle assembly 10 includes a housing or gear case 20 having a predetermined configuration with a pair of opposed apertures 20a, 20b therein. Preferably, the gear case 20 is die cast aluminum, although it is within the spirit and scope of the present invention that the gear case 20 be made from a different material, provided it is still capable of functioning as described below. Each of the apertures 20a, 20b is preferably aligned along a longitudinal axis X of the gear case 20. The gear case 20 has a gear case length G measured along the longitudinal axis X between the apertures 20a, 20b. Preferably, the gear case length G is less than the distance W between the mounting locations 94 of the chassis 92.

It is preferable that the gear case length G be a standard length so that multiple differently-sized molds for the gear case 20 are unnecessary, thereby reducing costs associated with the manufacture of the differential transaxle assembly 10. In this way, the length G and shape of the gear case 20 remains generally constant, regardless of the mounting length L of the differential transaxle assembly 10.

Preferably, the gear case 20 is a generally closed structure defining a cavity 21 therein. The apertures 20a, 20b are in communication with the cavity 21 to form openings between the cavity 21 and the outside. The gear case 20 preferably has a removable cover 20c to allow access to the cavity 21 within the gear case 20.

A first output shaft 22 is rotatably positioned in one of the apertures 20a of the gear case 20. The first output shaft 22 is at least substantially aligned with the longitudinal axis X of the gear case 20. The first output shaft 22 has a first outboard end 22a disposed outside of the gear case 20 and a first inboard end 22b disposed within the cavity 21. A second output shaft 24 is rotatably positioned in the other of the apertures 20b of the gear case 20 and is at least substantially aligned with the longitudinal axis X of the gear case 20. The second output shaft 24 has a second outboard end 24a disposed outside of the gear case 20 and a second inboard end 24b disposed within the cavity 21. It is preferable that the first output shaft 22 is longer than the second output shaft 24, although it is within the spirit and scope of the present invention that the first output shaft 22 is shorter than the second output shaft 24 or that the first and second output shafts 22, 24 are the same size. Preferably, the first and second output shafts 22, 24 are made of steel alloy, although it is within the spirit and scope of the present invention that another material be used, provided the alternate material is capable of functioning as described below.

Conventional bearings 30 are preferably disposed around the first and second output shafts 22, 24, within the apertures 20a, 20b between the gear case 20 and the first and second output shafts 22, 24, in order to allow the first and second output shafts 22, 24 to rotate with respect to the gear case 20. Preferably, the first and second output shafts 22, 24 include splines 22c, 24c proximate the outboard ends 22a, 24a thereof in order to rotationally fix the wheels 96 of the scooter 90 thereto once the differential transaxle assembly 10 is mounted to the chassis 92.

An electric motor 12 or other propulsion device is preferably fixed to the outside of the gear case 20 and is oriented so that an output shaft 13 of the motor 12 is directed toward an opening 20d in the gear case 20. The motor 12 is preferably powered by a conventional rechargeable battery.

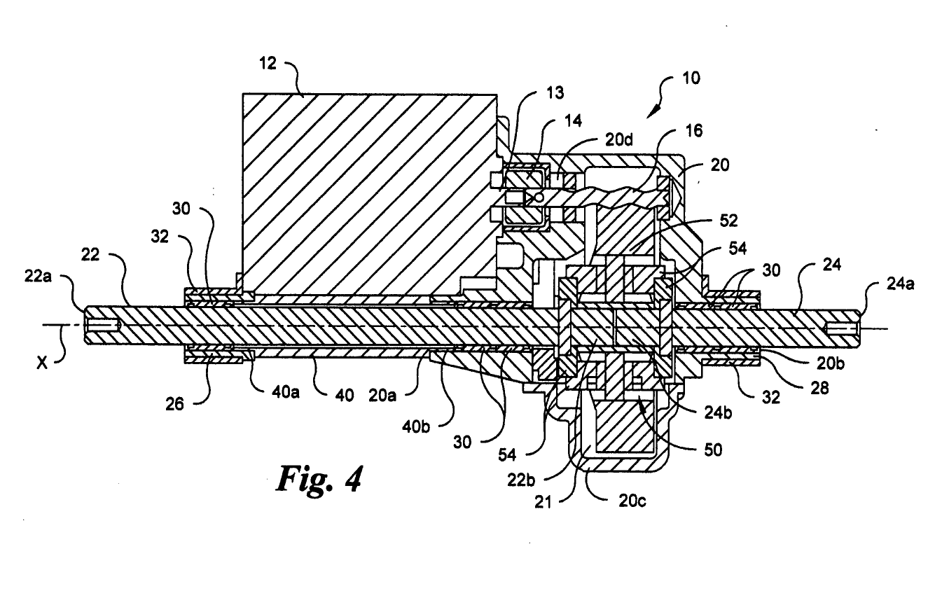

Referring to FIG. 4, a drive pinion 16 is affixed to an end of the output shaft 13 via a motor coupling 14. Preferably, the drive pinion 16 is disposed substantially within the cavity 21 of the gear case 20. The drive pinion 16 preferably engages with and drives a differential gear assembly 50 within the cavity 21 of the gear case 20. The gear assembly 50 is preferably in operative engagement with the first and second inboard ends 22b, 24b of the first and second output shafts 22, 24 for transferring torque to the first and second output shafts 22, 24. The gear assembly 50 generally includes a drive gear 52, which is driven by the drive pinion 16, and four differential bevel gears 54 for operatively engaging the drive gear 52 to the first and second output shafts 22, 24. In this way, torque generated by the motor 12 is transferred to the first and second output shafts 22, 24 in order to ultimately drive the wheels 96 of the scooter 90. Additional details and description of the gear assembly 50 and other features of the gear case 20 are set forth in U.S. Pat. No. 6,626,788 B2, which is incorporated by reference herein.

Referring again to FIGS. 2-4, first and second supports 26, 28 are used for connecting the differential transaxle assembly 10 to the mounting locations 94 of the chassis 92. Preferably, the first support 26 is located proximate the first outboard end 22a of the first output shaft 22, and the second support 28 is located proximate the second outboard end 24a of the second output shaft 24. The first and second supports 26, 28 are preferably die cast aluminum with a generally rectangular outer surface (see FIG. 3) and a generally circular hole therethrough for accommodating one of the first and second output shafts 22, 24 therein. Preferably, conventional bearings 30 are disposed between the first and second output shafts 22, 24 and their respective first and second supports 26, 28 to allow the first and second output shafts 22, 24 to rotate with respect to the first and second supports 26, 28. A rubber sleeve 32 is preferably disposed around the outer, generally rectangular surfaces of the first and second supports 26, 28. The second support 28 is preferably integrally molded with the gear case 20 so that the hole through the second support 28 corresponds with the second aperture 20b of the gear case. Although this is preferred, it is within the spirit and scope of the present invention that the second support 28 be formed separately from the gear case 20.

The differential transaxle assembly 10 further includes a tube 40 formed separately from the gear case 20. The tube 40 has a first end 40a and a second end 40b oppositely disposed from the first end 40a. The tube 40 has a tube length T measured between the first and second ends 40a, 40b. The first end 40a of the tube 40 is secured to one of the first and second supports 26, 28, and the second end 40b of the tube 40 is secured to the gear case 20. The tube 40 surrounds at least one of the first and second output shafts 22, 24. The tube 40 is preferably die cast aluminum, although it is within the spirit and scope of the present invention that the tube 40 be formed from a different material using a different process provided the tube 40 is still capable of functioning as described herein.

Preferably, the tube 40 is disposed between the first support 26 and the gear case 20 to substantially cover the first output shaft 22. Although this is preferred, it is within the spirit and scope of the present invention that the tube 40 be used to cover the second output shaft 24 or that separate tubes 40 be used to cover both the first and second output shafts 22, 24. Preferably, the tube 40 has a substantially circular cross-section with the first and second ends 40a, 40b of the tube 40 having diameters that are sufficiently small to fit within at least the first aperture 20a of the gear case 20 and the hole through the first support 26 to enable the insertion of the first and second ends 40a, 40b of the tube 40 therein. It is preferred that a wall thickness of the tube 40 is decreased proximate the first and second ends 40a, 40b in order to allow the tube 40 to fit within the holes of the first support 26 and the first 20a of the gear case 20. Although this is preferred, it is within the spirit and scope of the present invention that the tube 40 has a uniform wall thickness along the entire tube length T and a uniform diameter of the tube 40 that is sufficiently sized to fit within the first aperture 20a and the hole of the first support 26.

Referring to FIGS. 1-4, preferably, the first and second ends 40a, 40b of the tube 40 are secured within the first aperture 20a of the gear case 20 and the hole of the first support 26, respectively, using press fitting and/or locking fluids. The tube 40 is additionally secured within the differential transaxle assembly 10 due to the mounting of the differential transaxle assembly 10 to the chassis 92. That is, once the first and second supports 26, 28 are attached to the mounting locations 94 of the chassis 92, the first and second supports 26, 28 are basically fixed with respect to the differential transaxle assembly 10, restraining the components of the differential transaxle assembly 10 from moving along the longitudinal axis X and essentially trapping the tube 40 between the first support 26 and the gear case 20.

The tube length T is determined to enable the first and second supports 26, 28 of the assembled differential transaxle assembly 10 to be appropriately spaced to correspond to the mounting locations 94 of the particular chassis 92 with which the differential transaxle assembly 10 is being used. That is, the mounting length L of the differential transaxle assembly 10, measured between the first and second supports 26, 28, is essentially equal to the gear case length G plus the tube length T. In order to properly mount the differential transaxle assembly 10 to the chassis 92, the mounting length L of the differential transaxle assembly 10 must correspond to the distance W between the mounting locations 94 of the chassis 92 so that the first and second supports 26, 28 align with the mounting locations 94.

As stated above, the gear case length G is generally standard. Although the gear case length G could be changed by using a different mold, doing so would increase the manufacturing cost and time of the gear case 20, which, in most instances, would not be practical from a business standpoint. However, the tube length T of the tube 40 can be relatively easily and inexpensively formed to an appropriate size using various methods, including, but not limited to, machining at least one of the first and second ends 40a, 40b of the tube 40 to size. In this way, the length L of the differential transaxle assembly 10 can be varied to correspond with the distance W between the mounting locations 94 of the chassis 92 by varying the tube length T of the tube 40. This allows the first and second supports 26, 28 of the differential transaxle assembly 10 to correspond and align with the mounting locations 94 of the chassis 92 so that the differential transaxle assembly 10 can be mounted to the chassis 92.

It is preferred that the mounting locations 94 each have a top and a bottom surface defining a space therebetween. It is within these spaces that the first and second supports 26, 28 of the differential transaxle assembly 10 are inserted. The bottom surfaces of the mounting locations 94 are then bolted or otherwise affixed to the top surfaces in order to compress the first and second supports 26, 28 therebetween and retain the differential transaxle assembly 10 on the chassis 92. Although this method of mounting is preferred, it is within the spirit and scope of the present invention that the differential transaxle assembly 10 be mounted in other ways, such as, for instance, bolting or otherwise affixing the first and second supports 26, 28 directly to the chassis 92.

When the differential transaxle assembly 10 is fully assembled, the second support 28 is preferably integrally molded with the gear case 20 and the tube 40 is secured between the gear case 20 and the first support 26, as stated above. In this way, the differential transaxle assembly 10 forms a relatively rigid structure between the first and second supports 26, 28. During operation of the differential transaxle assembly 10, a torque is produced. When mounted to the chassis 92, this torque translates to a reaction torque experienced at the first and second supports 26, 28 and the corresponding mounting locations 94. Because the differential transaxle assembly 10 forms a relatively rigid structure, the reaction torque is substantially equally distributed between the first and second supports 26, 28. This situation is more favorable than having only one of the first and second supports 26, 28 experience the majority of the reaction torque, which would be the case if no tube 40 or other structure were rigidly connected between the gear case 20 and the first or second support 26, 28.

By substantially covering one of the first and second output shafts 22, 24, the tube 40 is able to help protect the first or second output shaft 22, 24 from water and/or dirt to decrease the possibility of corrosion of the first or second output shaft 22, 24. Additionally, by at least partially shielding at least one of the first and second output shafts 22, 24 from being contacted, the tube 40 acts to help protect people and animals in the vicinity of the differential transaxle assembly 10 from being injured by at least one of the first and second output shafts 22, 24, which can rotate at relatively high speeds during operation of the differential transaxle assembly 10.

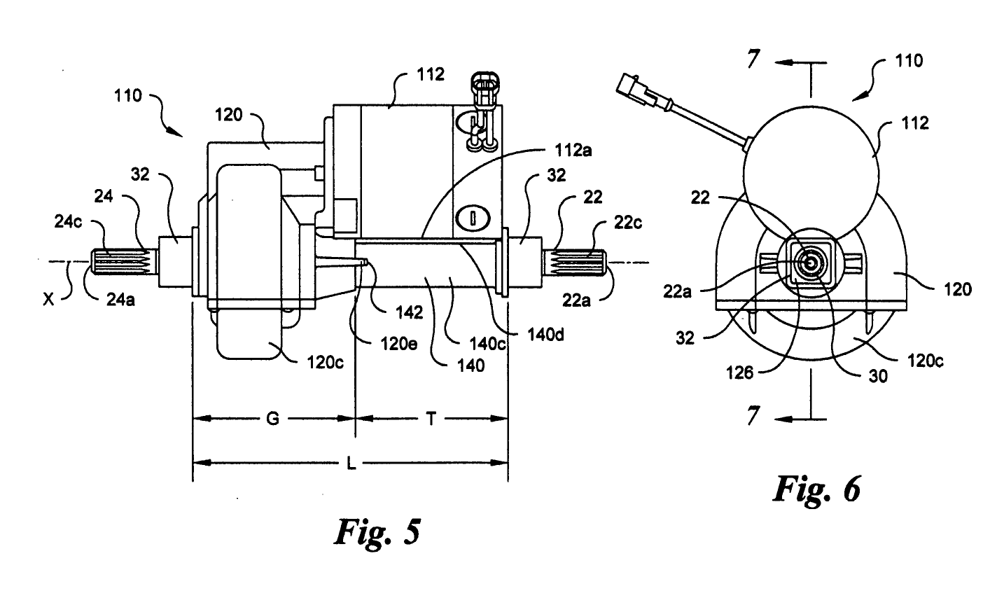

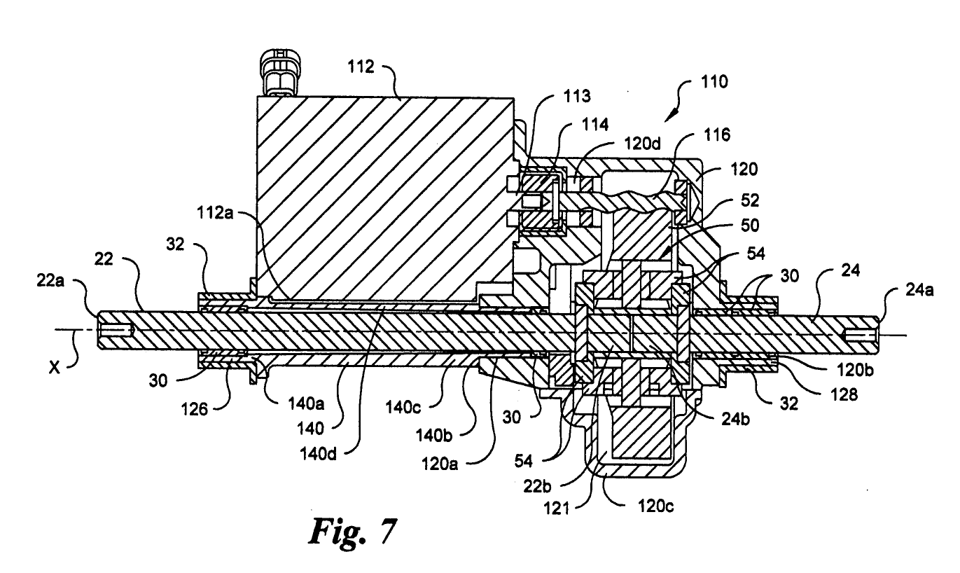

Referring to FIGS. 5-8, there is shown a differential transaxle assembly 110 of a second preferred embodiment which is generally similar to the differential transaxle assembly 10 of the first preferred embodiment with the main differences being in the shape and configuration of a tube 140. As such, only the differences between the first and second preferred embodiments will be discussed.

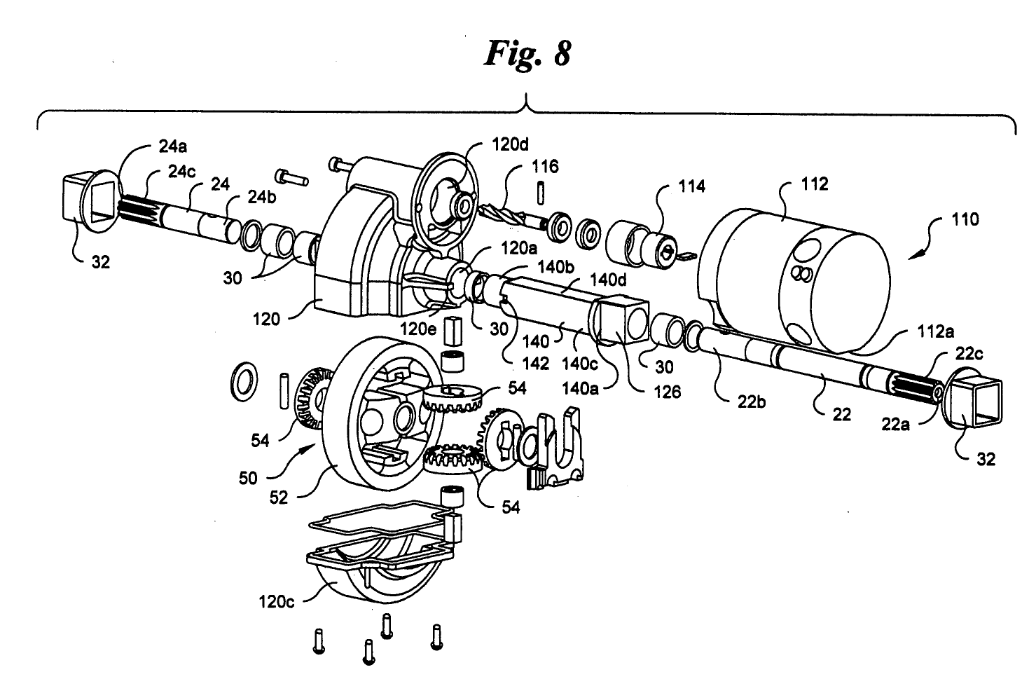

Referring to FIGS. 5 and 8, the tube 140 has a side wall having a rounded portion 140c and a flat portion 140d, rather than having a circular cross-section like the tube 40 of the first preferred embodiment. It is intended that the flat portion 140d of the tube 140 abuts or is otherwise proximate a corresponding flat surface 112a of a motor 112, which is located proximate the tube 140 when the differential transaxle assembly 110 is assembled. The flat portion 140d of the tube 140 provides additional clearance so that a larger motor 112 can be used with the differential transaxle assembly 110 than would otherwise be able to be used if the tube 140 had a different shape, such as being circular in cross-section, for instance.

The tube 140 further includes at least one indentation 142 in the side wall thereof proximate a second end 140b. The at least one indentation 142 is sufficiently sized and shaped for interaction with at least one corresponding protrusion 120e of a gear case 120. When the second end 140b of the tube 140 is inserted within an aperture 120a of the gear case 120, the at least one protrusion 120e is disposed within the at least one indentation 142 of the tube 140 to restrain the tube 140 from rotating with respect to the gear case 120 during operation of the differential transaxle assembly 110. Preferably, there are two diametrically opposed indentations 142 in the tube 140 and two corresponding protrusions 120e of the gear case 120. Although this is preferred, it is within the spirit and scope of the present invention that there be more or less than two indentations 142 and corresponding protrusions 120e.

Lastly, the tube 140 of the second preferred embodiment has a first support 126 at a first end 140a of the tube 140. However, rather than being secured thereto using a press fitting and/or locking fluids like in the first preferred embodiment, the first support 126 of the second preferred embodiment is integrally molded or formed with the tube 140. In this way, a rigid connection is formed between the tube and the first support 126 to ensure that the two components do not become separated during operation of the differential transaxle assembly 110, short of a catastrophic failure of the tube 140.

The remaining structure and operation of the differential transaxle assembly 110 is essentially similar to that described above with respect to the differential transaxle assembly 10 of the first preferred embodiment.

In another aspect, the present invention is a method for assembling the differential transaxle assembly 10, 110 for use with the chassis 92 having a pair of mounting locations 94 spaced apart a predetermined distance W. Initially, the gear case 20, 120 is formed having a cavity 21, 121 and opposed apertures 20a, 20b, 120a, 120b aligned along a longitudinal axis X of the gear case 20. The apertures 20a, 20b, 120a, 120b are in communication with the cavity 21, 121. The gear case 20, 120 has a predetermined length G measured between the apertures 20a, 20b, 120a, 120b. The gear case length G is less than the distance W between the mounting locations 94 of the chassis 92.

Next, the first output shaft 22 is positioned in one of the apertures 20a, 20b, 120a, 120b, such that the first output shaft 22 is at least substantially aligned with the longitudinal axis X of the gear case 20, 120. The first output shaft is positioned so that the first inboard end 22b is located within the cavity 21, 121 and the first outboard end 22a is disposed outside of the gear case 20, 120.

The second output shaft 24 is then positioned in the other of the apertures 20b, 20a, 120b, 120a, such that the second output shaft 24 is at least substantially aligned with the longitudinal axis X of the gear case 20, 120. The second output shaft 24 is positioned within the aperture 20b, 20a, 120b, 120a, such that the second inboard end 24b is disposed within the cavity 21, 121 and the second outboard end 24a is disposed outside of the gear case 20, 120.

The gear assembly 50 is now positioned within the cavity 21, 121 in operative engagement with the first and second inboard ends 22b, 24b of the first and second output shafts 22, 24 for transferring torque to the first and second output shafts 22, 24.

The tube 40, 140 is then formed or selected with a particular tube length T, as measured between the first end 40a, 140a and the oppositely disposed second end 40b, 140b. The second end 40b, 140b of the tube 40, 140 is secured to one of the apertures 20a, 20b, 120a, 120b of the gear case 20, 120 so that the tube 40, 140 is at least substantially aligned with the longitudinal axis X of the gear case 20, 120, with one of the first and second output shafts 22, 24 disposed within the tube 40, 140. The first support 26, 126 is located at the first end 40a, 140a of the tube 40, 140. The second support 28, 128 is then located proximate the other of the apertures 20b, 20a, 120b, 120a of the gear case 20, 120.

During manufacture and assembly of the differential transaxle assembly 10, 110, the tube length T is determined according to the distance W between the mounting locations 94 of the chassis 92 so that the first and second supports 26, 28, 126, 128 correspond and align with the mounting locations 94 of the chassis 92. In this way, the differential transaxle assembly 10, 110 can be used with chassis of different vehicles or machines, which have different distances between the mounting locations of the respective vehicles or machines.

When assembling the differential transaxle assembly 10 of the first preferred embodiment, the first end 40a of the tube 40 is secured to the first support 26, and the second end 40b of the tube 40 is secured to the gear case 20 using a press fitting and/or locking fluids. When assembling the differential transaxle assembly 110 of the second preferred embodiment, the first support 126 is integrally molded with the first end 140a of the tube 140, and the second end 140b of the tube 140 is secured to the gear case 120 using press fitting and/or locking fluids.

The differential transaxle assembly 10, 110 described above improves upon the prior art in that it can be manufactured for a cost that is reduced from that of the conventional designs. By separately forming the tube 40, 140 from the gear case 20, 120, less complicated molds and molding techniques can be used, thereby resulting in a reduced manufacturing cost. Additionally, because the length L of the differential transaxle assembly 10, 110 can be relatively easily changed by changing the tube length T of the tube 40, 140, the differential transaxle assembly 10, 110 is capable of being mounted on a variety of different chassis. Moreover, because only the tube length T need be altered to change the mounting length L of the differential transaxle assembly 10, 110, the gear case 20, 120 can be manufactured with a standard gear case length G to eliminate the need for differently-shaped molds for the gear case 20, 120, thereby further reducing the manufacturing cost. Lastly, because the tube 40, 140 substantially completely encloses at least one of the first and second output shafts 22, 24, the tube 40, 140 protects at least one of the first and second output shafts 22, 24 from dirt and/or water to reduce the possibility of corrosion of at least one of the first and second output shafts 22, 24. Moreover, because the tube 40, 140 shields at least one of the first and second output shafts 22, 24, the likelihood of physical injury from contacting at least one of the rotating first and second output shafts 22, 24 is drastically reduced from that of an uncovered rotating shaft.

It will be appreciated by those skilled in the art that changes could be made to the embodiments described above without departing from the broad inventive concepts thereof. It is understood, therefore, that this invention is not limited to the particular embodiments disclosed, but it is intended to cover modifications within the spirit and scope of the present invention as defined by the appended claims.

1. A differential transaxle assembly for use with any one of a plurality of different chassis, each chassis having a pair of mounting locations spaced apart a predetermined distance, each of the different chassis having a different distance between the mounting locations, the differential transaxle assembly comprising:
a gear case having a predetermined configuration with a pair of opposed apertures therein, each of the apertures being aligned along a longitudinal axis of the gear case, the gear case having a gear case length measured along the longitudinal axis between the apertures, the gear case length being less than the distances between the mounting locations of the different chassis;
a first output shaft rotatably positioned in one of the apertures and being at least substantially aligned with the longitudinal axis of the gear case, the first output shaft having a first outboard end disposed outside of the gear case;
a second output shaft rotatably positioned in the other of the apertures and being at least substantially aligned with the longitudinal axis of the gear case, the second output shaft having a second outboard end disposed outside of the gear case;
first and second supports for connecting the differential transaxle assembly to the mounting locations of the chassis, the first support being located proximate the first outboard end of the first output shaft and the second support being located proximate the second outboard end of the second output shaft; and
a tube separate from the gear case having a first end and an oppositely disposed second end and defining a tube length measured between the first and second ends, the first end of the tube being secured to one of the first and second supports and the second end of the tube being secured to the gear case, the tube surrounding at least one of the first and second output shafts, wherein the tube length is such to enable the first and second supports to be appropriately spaced to correspond to the mounting locations of the particular chassis with which the differential transaxle assembly is being used.

2. The differential transaxle assembly of claim 1, wherein the tube is disposed between the first support and the gear case.

3. The differential transaxle assembly of claim 1, wherein the tube has a substantially circular cross-section.

4. The differential transaxle assembly of claim 1, wherein a reaction torque produced during operation of the differential transaxle assembly is substantially equally distributed between the first and second supports.

5. The differential transaxle assembly of claim 1, wherein the tube acts to protect at least one of the first and second output shafts from at least one of water and dirt.

6. The differential transaxle assembly of claim 1, further comprising bearings disposed between the first and second supports and the first and second output shafts, such that the first and second output shafts are rotatable with respect to the first and second supports.

7. The differential transaxle assembly of claim 1, wherein the ends of the tube are secured using at least one of press fitting and locking fluids.

8. The differential transaxle assembly of claim 1, wherein a cavity is defined within the gear case, the apertures being in communication with the cavity, such that first and second inboard ends of the first and second output shafts are disposed within the cavity, the differential transaxle assembly further comprising a gear assembly within the cavity in operative engagement with the first and second inboard ends of the first and second output shafts for transferring torque to the first and second output shafts.

9. A differential transaxle assembly for use with any one of a plurality of different chassis, each chassis having a pair of mounting locations spaced apart a predetermined distance, each of the different chassis having a different distance between the mounting locations, the differential transaxle assembly comprising:
a gear case having a predetermined configuration with a pair of opposed apertures therein, each of the apertures being aligned along a longitudinal axis of the gear case, the gear case having a gear case length measured along the longitudinal axis between the apertures, the gear case length being less than the distances between the mounting locations of the different chassis;
a first output shaft rotatably positioned in one of the apertures and being at least substantially aligned with the longitudinal axis of the gear case, the first output shaft having a first outboard end disposed outside of the gear case;
a second output shaft rotatably positioned in the other of the apertures and being at least substantially aligned with the longitudinal axis of the gear case, the second output shaft having a second outboard end disposed outside of the gear case;
first and second supports for connecting the differential transaxle assembly to the mounting locations of the chassis, the first support being located proximate the first outboard end of the first output shaft and the second support being located proximate the second outboard end of the second output shaft; and
a tube separate from the gear case having a first end and an oppositely disposed second end and defining a tube length measured between the first and second ends, the first end of the tube being integrally molded with one of the first and second supports and the second end of the tube being secured to the gear case, the tube surrounding at least one of the first and second output shafts, wherein the tube length is such to enable the first and second supports to be appropriately spaced to correspond to the mounting locations of the particular chassis with which the differential transaxle assembly is being used.

10. The differential transaxle assembly of claim 9, wherein the tube is disposed between the first support and the gear case, the tube being integrally molded with the first support.

11. The differential transaxle assembly of claim 9, wherein the tube has a sidewall having a rounded portion and a generally flat portion.

12. The differential transaxle assembly of claim 9, wherein a reaction torque produced during operation of the differential transaxle assembly is substantially equally distributed between the first and second supports.

13. The differential transaxle assembly of claim 9, wherein the tube acts to protect at least one of the first and second output shafts from at least one of water and dirt.

14. The differential transaxle assembly of claim 9, further comprising bearings disposed between the first and second supports and the first and second output shafts, such that the first and second output shafts are rotatable with respect to the first and second supports.

15. The differential transaxle assembly of claim 9, wherein the second end of the tube is secured to the gear case using at least one of press fitting and locking fluids.

16. The differential transaxle assembly of claim 9, wherein the tube includes at least one indentation in a sidewall thereof proximate the second end, the gear case including at least one protrusion for engagement within the at least one indentation in the tube when the tube is secured to the gear case.

17. The differential transaxle assembly of claim 9, wherein a cavity is defined within the gear case, the apertures being in communication with the cavity, such that first and second inboard ends of the first and second output shafts are disposed within the cavity, the differential transaxle assembly further comprising a gear assembly within the cavity in operative engagement with the first and second inboard ends of the first and second output shafts for transferring torque to the first and second output shafts.

18. A method for assembling a differential transaxle assembly for use with a chassis having a pair of mounting locations spaced apart a predetermined distance, comprising the steps of:
forming a gear case having a cavity and a pair of opposed apertures in communication with the cavity, such that each of the apertures are aligned along a longitudinal axis of the gear case, the gear case having a predetermined length measured between the apertures, the gear case length being less than the distance between the mounting locations of the chassis;
positioning a first output shaft in one of the apertures, such that the first output shaft is at least substantially aligned with the longitudinal axis of the gear case, the first output shaft having a first inboard end within the cavity and a first outboard end disposed outside of the gear case;
positioning a second output shaft in the other of the apertures, such that the second output shaft is at least substantially aligned with the longitudinal axis of the gear case, the second output shaft having a second inboard end within the cavity and a second outboard end disposed outside of the gear case;
positioning a gear assembly within the cavity in operative engagement with the first and second inboard ends of the first and second output shafts for transferring torque to the first and second output shafts;
forming a tube having a first end and an oppositely disposed second end defining a tube length measured therebetween;
securing the second end of the tube to one of the apertures of the gear case so that the tube is at least substantially aligned with the longitudinal axis of the gear case with one of the first and second output shafts disposed within the tube;
locating a first support at the first end of the tube; and
locating a second support proximate the other of the apertures of the gear case;
wherein the tube length is determined according to the distance between the mounting locations of the chassis so that the first and second supports correspond and align with the mounting locations of the chassis.

19. The method for assembling a differential transaxle assembly of claim 18, wherein the first end of the tube is secured to the first support and the second end of the tube is secured to the gear case using at least one of press fitting and locking fluids.

20. The method for assembling a differential transaxle assembly of claim 18, wherein the first support is integrally molded with the first end of the tube and the second end of the tube is secured to the gear case using at least one of press fitting and locking fluids.
